(19) United States
(12) Patent Application Publication
(10) Pub. No.: US 2006/0281433 A1
(43) Pub. Date: Dec. 14, 2006

(54) Method and apparatus for demodulation

(75) Inventors: John-San Yang, Hsinchu County (TW); Chung-Cheng Wang, Taipei County (TW); Yu-Hua Liu, Hsinchu County (TW)

Correspondence Address: BIRCH STEWART KOLASCH & BIRCH, PO BOX 747, FALLS CHURCH, VA, 22040-0747, US

(73) Assignee: Airoha Technology Corp.

(21) Appl. No.: 11/451,425

(22) Filed: Jun. 13, 2006

(30) Foreign Application Priority Data
Jun. 13, 2005 (TW) 94119471

(51) Int. Cl. H04B 1/26

(52) U.S. Cl. 455/323

(57) ABSTRACT

A demodulation method and apparatus are provided. An RF signal is down converted to generate a first in-phase signal and a first quadrature signal of a first frequency. Limiting amplification is performed on the first in-phase signal and the first quadrature signal to generate a second in-phase signal and a second quadrature signal. The frequency of the second in-phase and quadrature signals are up converted to a third in-phase signal and a quadrature signal of a second frequency. The third in-phase and quadrature signals are up converted to generate an intermediate frequency (IF) signal of a third frequency.

### BACKGROUND

The invention relates to RF receivers, and in particular, to a demodulation method and apparatus simplifying frequency up and down conversions.

FIG. 1a shows a conventional direct transmitter. A base band signal is provided by a digital signal processor (DSP) 110, processing through two paths, in-phase and quadrature, before transmitting. The digital to analog converters (DAC) 102 digitize the base band signal, the low pass filters (LPF) 104 eliminate noise components, and the variable gain amplifiers (VGA) 106 integrate the signal powers before modulation. Thereafter, the mixer 108 modulates the digital baseband signals by an oscillation frequency generated by a reference generator 130, generating an RF signal. The RF signal is further amplified by a limiting amplifier 140, filtered by an RF filter 150 to eliminate image components, amplified by an amplifier 160 to boost power, and then transmitted via the antenna 120.

FIG. 1b shows a conventional zero intermediate frequency (ZIF) receiver. The demodulation process is subsequently reverse of the transmission in FIG. 1a. The antenna 120 receives the RF signal, the RF filter 150 eliminates unnecessary noise in the RF signal. The filtered RF signal is then amplified by the low noise amplifier (LNA) 114, and demodulated by the mixer 108. The mixer 108 directly down converts the RF signal to a baseband signal based on the oscillation frequency generated from a reference generator 130. The baseband signals are divided into in-phase and quadrature components individually processed. In FIG. 1b, the LPFs 104 eliminate image components in the baseband signals, and the VGAs 106 integrate the magnitude thereof. Thereafter, the ADCs 112 digitize the baseband signals to digital baseband signals output to the DSP 110. The ZIF architecture, also referred to as a direct conversion architecture, down converts the RF signal directly to a baseband signal without IF stages, thus image interference can be avoided. The image components, however, are down converted to baseband, causing DC offset problems that impact signal quality for the DSP 110. Therefore a very low intermediate frequency (VLIF) architecture is proposed.

FIG. 1c shows a conventional very low intermediate frequency (VLIF) receiver. In this case, the mixer 108 does not directly down convert the RF signal to a baseband signal. To the contrary, the RF signal is down converted to a low frequency. The low frequency is typically ¼ channel spacing, for example, 150 KHz for a PHS system. The low frequency signal is then filtered by a band pass filter 105, eliminating image components and reserving low frequency components. The advantages of the VLIF architecture are, high integratablity and a lack of DC offset problems, thus VLIF is applicable for general narrow band communications such as GSM compared to the conventional super heterodyne architecture or ZIF architecture. Additionally, the VLIF architecture has greater signal strength than the ZIF architecture.

The RF signal is down converted to baseband or low frequency without intermediate stages, thus, the ZIF and VLIF architectures can not be utilized for a system requiring IF signals, such as a PHS system. Although a super heterodyne architecture may generate an IF signal, the implementation of the surface acoustic wave (SAW) filter, however, is too complicated to integrate in one chip. Thus, an integrated IF demodulator is desirable.

### SUMMARY

An exemplary RF receiver is provided, comprising a down converter, a harmonic filter, a first and second up converter. The down converter receives and down converts an RF signal to a first frequency to generate a first in-phase signal and a first quadrature signal. The harmonic filter coupled to the down converter receives the first in-phase signal and the first quadrature signal, and performs limiting amplification to generate a second in-phase signal and a second quadrature signal. The first up converter coupled to the harmonic filter receives the second in-phase and quadrature signals, up converting the frequency thereof to a second frequency to generate a third in-phase signal and a quadrature signal. The second up converter coupled to the first up converter receives the third in-phase and quadrature signals and up converts the frequency thereof to a third frequency to generate an intermediate frequency (IF) signal.

The RF receiver further comprises a local oscillator comprising a reference generator, a PLL circuit, a first divider and a second divider. The reference generator provides a reference signal. The PLL circuit coupled to the reference generator generates a first sinusoidal wave and a first cosine wave based on the reference signal. The first divider coupled to the reference generator generates a second sinusoidal wave and a second cosine wave by looking up a digital table based on the reference signal. The second divider coupled to the reference generator generates a third sinusoidal wave and a third cosine wave based on the reference signal. The reference signal is 19.2 MHz, the first frequency is 1.75 GHz, the second frequency is 1.05 MHz, and the third frequency is 9.6 MHz.

Another embodiment of the invention provides a demodulation method. An RF signal is down converted to generate a first in-phase signal and a first quadrature signal of a first frequency. Limiting amplification is performed on the first in-phase signal and the first quadrature signal to generate a second in-phase signal and a second quadrature signal. The frequency of the second in-phase and quadrature signals are up converted to a third in-phase signal and a quadrature signal of a second frequency. The third in-phase and quadrature signals are up converted to generate an intermediate frequency (IF) signal of a third frequency.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1a shows a conventional direct transmitter;

FIG. 1b shows a conventional zero intermediate frequency (ZIF) receiver;

FIG. 1c shows a conventional very low intermediate frequency (VLIF) receiver;

FIG. 2 shows an embodiment of the RF receiver;

FIG. 3 shows an embodiment of the local oscillator;

FIG. 4 shows an embodiment of the RF system; and

FIG. 5 is a flowchart of the RF signal demodulation method.

### DETAILED DESCRIPTION

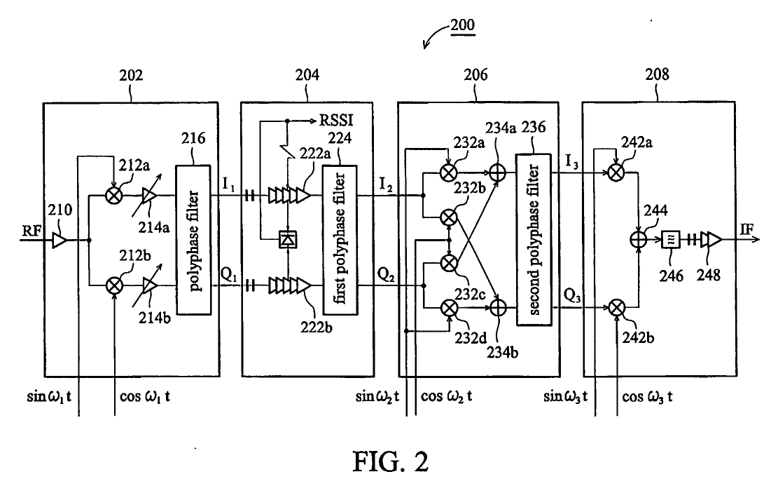

FIG. 2 shows an embodiment of the RF receiver. The RF receiver 200 comprises a down converter 202, a harmonic filter 204, a first up converter 206 and a second up converter 208, converting an RF signal to an IF signal. The down converter 202 first down converts the RF signal to a VLIF signal, generating a first in-phase signal I₁ and a first quadrature signal Q₁. The VLIF in this case, is 150 kilohertz (KHz). The first up converter 206 up converts the first in-phase signal I₁ and the first quadrature signal Q₁ to a third in-phase signal I₃ and a third quadrature signal Q₃ of a first frequency. The first frequency is 1.2 megahertz (MHz). The second up converter 208 further up converts the third in-phase signal I₃ and third quadrature signal Q₃ to the intermediate frequency (IF). The IF is 10.8 MHz in this case. The harmonic filter 204 eliminates harmonic components in the first in-phase signal I₁ and first quadrature signal Q₁. The down converters 202, first up converter 206 and second up converter 208 require corresponding oscillation frequencies to perform mixing. The down converter 202 mixes the RF signal by a first sinusoidal signal sin ω₁t and a first cosine signal cos ω₁t, and the mixed results are then amplified and filtered to obtain the first in-phase signal I₁ and the first quadrature signal Q₁. For a PHS system, the RF signal is 1.9 GHz, and the first sinusoidal signal sin ω₁t and first cosine signal cos ω₁t are 1.75 GHz. As a result, the first in-phase signal I₁ and first quadrature signal Q₁ are generated in the mixers 212a and mixer 212b, having a frequency of 150 KHz that avoids next-channel interference. In the down converter 202, the VGAs 214a, 214b and the polyphase filter 216 are conventional components performing image frequency rejection.

The harmonic filter 204 comprises limiting amplifiers 222a and 222b, amplifying the first in-phase signal I₁ and first quadrature signal Q₁ to make the amplitude unique without losing phase information. The first polyphase filter 224 eliminates harmonic components in the amplified first in-phase signal I₁ and first quadrature signal Q₁. Thus, as a conventional unit, the harmonic filter 204 is not further described herein.

The first up converter 206 comprises four mixers 232a to 232d, two adders 234 and a second polyphase filter 236. The mixers perform complex mixing to cancel the image components. A complex mixing algorithm is adaptable for a wide range frequency modulation/demodulation with excellent image rejection ability. The second cosine signal cos ω₂t and second sinusoidal signal sin ω₂t are 1.05 MHz, thereby the second in-phase signal I₂ and second quadrature signal Q₂ are mixed to obtain 1.2 MHz third in-phase signal I₃ and third quadrature signal Q₃. The mixer 232a multiplies the second in-phase signal I₂ by the second cosine signal cos ω₂t, and the mixer 232b multiplies the second in-phase signal I₂ and the second sinusoidal signal sin ω₂t. The mixer 232c multiplies the second quadrature signal Q₂ and the second sinusoidal signal sin ω₂t, and the mixer 232d multiplies the second quadrature signal Q₂ and the second cosine signal cos ω₂t. An adder 234a subtracts the output of mixer 232c from the output of mixer 232a, and an adder 234b adds the output of the mixers 232b and 232d. Thereafter, the second polyphase filter 236 filters the subtraction and the addition result to generate the third in-phase signal I₃ and third quadrature signal Q₃.

The third in-phase signal I₃ and third quadrature signal Q₃ are 1.2 MHz, and the second up converter 208 receives the third cosine signal cos ω₃t and third sinusoidal signal sin ω₃t of 9.6 MHz, thus the mixed IF is 10.8 MHz. The second up converter 208 comprises a mixer 242a mixing the third in-phase signal I₃ and the third sinusoidal signal sin ω₃t, and a mixer 242b mixing the third quadrature signal Q₃ and the third cosine signal cos ω₃t. An adder 244 adds the mixed results from the mixers 242a and 242b, and a band pass filter 246 filters the output from the adder 244 to reserve the IF components. The second up converter 208 also comprises a second limiting amplifier 248, amplifying the outputs from the band pass filter 246 to generate the IF signal.

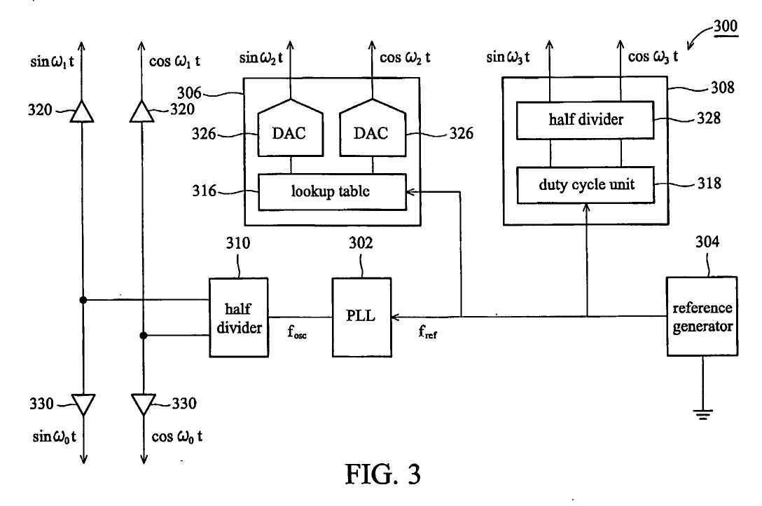

FIG. 3 shows an embodiment of the local oscillator 300. A typical PHS system comprises only one oscillation unit, a PLL circuit of 19.2 MHz. The local oscillator 300 is an integrated structure providing various oscillation signals by one PLL circuit. A reference generator 304 provides a f_{ref}, and a PLL 302 coupled to the reference generator 304, generates a f_{osc} from the f_{ref}. The first sinusoidal signal sin ω₁t and first cosine signal cos ω₁t are generated from the f_{osc} through a divider 310 and a pair of amplifiers 320. The 1.05 MHz second sinusoidal signal sin ω₂t and second cosine signal cos ω₂t are required to up convert the first in-phase signal I₁ and first quadrature signal Q₁ to a second in-phase signal I₂ and a second quadrature signal Q₂ of 1.2 MHz, thus a first divider 306 is coupled to the reference generator 304 to generate the second sinusoidal signal sin ω₂t and second cosine signal cos ω₂t by looking up a digital table based on the f_{ref}. The first divider 306 comprises a lookup table 316, converting the f_{ref} into a 1.05 MHz digital signal by looking up the table. The first divider 306 also comprises two DACs 326, each analogizes the output from the lookup table 316 to generate the second sinusoidal signal sin ω₂t and second cosine signal cos ω₂t.

The 9.6 MHz third sinusoidal signal sin ω₃t and third cosine signal cos ω₃t are required to up convert the second in-phase signal I₂ and second quadrature signal Q₂ to 10.8 MHz IF. A second divider 308 is coupled to the reference generator 304, dividing the 19.2 MHz f_{ref} by half to obtain the desired third sinusoidal signal sin ω₃t and third cosine signal cos ω₃t. The second divider 308 comprises a duty cycle unit 318, generating a square wave from the f_{ref} having a duty cycle of 1:1 to improve sideband rejection quality. A half divider 328 then divides the frequency of the square wave by half to obtain the third sinusoidal signal sin ω₃t and the third cosine signal cos ω₃t. In local oscillator 300, only one PLL is required, making the implementation compact, reducing cost and avoiding interference problems.

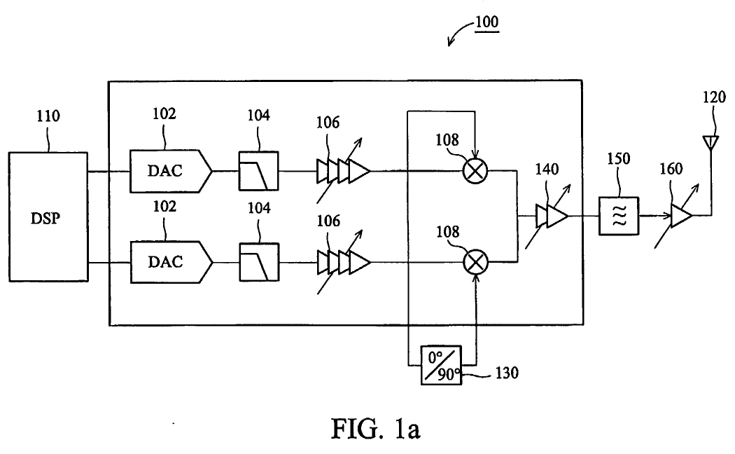

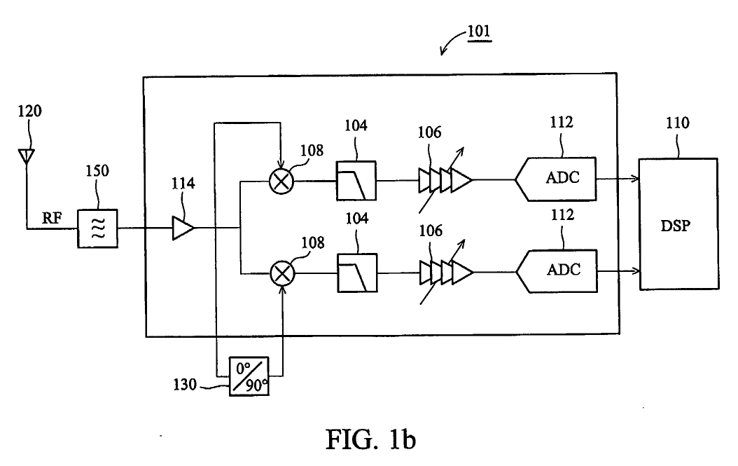

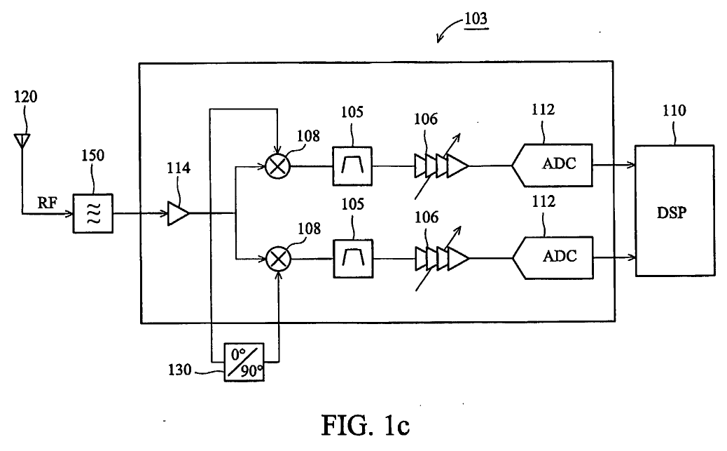

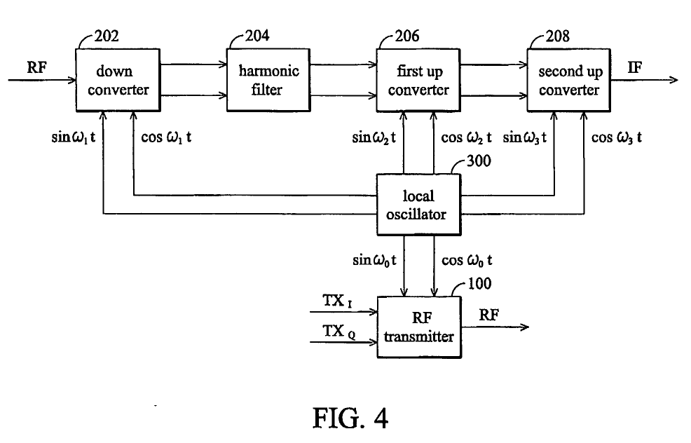

FIG. 4 shows an embodiment of the RF system integrating the transmitter in FIG. 1a and the receiver in FIG. 2. With the local oscillator 300, various oscillation frequencies are provided for the down converter 202, first up converter 206, second up converter 208 and the transmitter 100. In this architecture, the advantage of VLIF is obtained while generating IF. Since only one local oscillator 300 is required, the cost of VCO circuits is reduced.

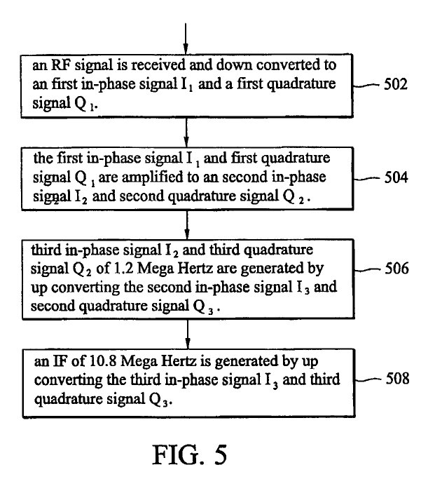

FIG. 5 is a flowchart of the RF signal demodulation method. In step 502, an RF signal is received and down converted to a first frequency, generating a first in-phase signal I₁ and a first quadrature signal Q₁. The RF is 1.9 GHz, and the first in-phase signal I₁ and first quadrature signal Q₁ are 150 KHz. In step 504, the first in-phase signal I₁ and first quadrature signal Q₁ are amplified to a second in-phase signal I₂ and second quadrature signal Q₂. In step 506, a third in-phase signal I₃ and third quadrature signal Q₃ of 1.2 MHz are generated by up converting the second in-phase signal I₂ and second quadrature signal Q₂. In step 508, an IF of 10.8 MHz is generated by up converting the third in-phase signal I₃ and third quadrature signal Q₃.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An RF receiver, comprising:
a down converter, receiving an RF signal, and down converting the RF signal to a first frequency to generate a first in-phase signal and a first quadrature signal;
a harmonic filter, coupled to the down converter, receiving the first in-phase signal and the first quadrature signal, and performing limiting amplification to generate a second in-phase signal and a second quadrature signal;
a first up converter, coupled to the harmonic filter, receiving the second in-phase and quadrature signals, up converting the frequency thereof to a second frequency to generate a third in-phase signal and a quadrature signal; and
a second up converter, coupled to the first up converter, receiving the third in-phase and quadrature signals and up converting the frequency thereof to a third frequency to generate an intermediate frequency (IF) signal.

2. The RF receiver as claimed in claim 1, wherein the down converter receives a first sinusoidal wave and a first cosine wave to mix the RF signal, and the mixed result is then amplified and filtered to obtain the first in-phase signal and the first quadrature signal.

3. The RF receiver as claimed in claim 1, wherein the harmonic filter comprises:
a limiting amplifier, amplifying the first in-phase signal and the first quadrature signal; and
a first polyphase filter, eliminating harmonic components in the amplification result of the first in-phase signal and the first quadrature signal to generate the second in-phase signal and the second quadrature signal.

4. The RF receiver as claimed in claim 1, wherein the first up converter comprises:
a first mixer, mixing the second in-phase signal and a second cosine wave;
a second mixer, mixing the second in-phase signal and a second sinusoidal wave;
a third mixer, mixing the second quadrature signal and the second sinusoidal wave;
a fourth mixer, mixing the second quadrature signal and the second cosine wave;
a first adder, subtracting the output of the third mixer from the output of the first mixer;
a second adder, adding the outputs of the second mixer and the fourth mixer; and
a second polyphase filter, filtering the outputs from the first and second adders to generate the third in-phase signal and the third quadrature signal.

5. The RF receiver as claimed in claim 1, wherein the second up converter comprises:
a fifth mixer, receiving and mixing the third in-phase signal and the third cosine signal;
a sixth mixer, receiving and mixing the third quadrature signal and the third sinusoidal signal;
a third adder, adding the outputs from the fifth and sixth mixers;
a band pass filter (BPF), filtering the output from the third adder to reserve third frequency signals; and
a second limiting amplifier, amplifying the output from the BPF to generate the IF signal.

6. The RF receiver as claimed in claim 1, further comprising a local oscillator comprising:
a reference generator, providing a reference signal;
a PLL circuit, coupled to the reference generator, generating a first sinusoidal wave and a first cosine wave based on the reference signal, wherein the first sinusoidal wave and the first cosine wave have a first frequency;
a first divider, coupled to the reference generator, generating a second sinusoidal wave and a second cosine wave by looking up a digital table based on the reference signal, wherein the second sinusoidal wave and the second cosine wave have a second frequency;
a second divider, coupled to the reference generator, generating a third sinusoidal wave and a third cosine wave based on the reference signal, wherein the third sinusoidal wave and the third cosine wave have a third frequency; wherein
the reference signal is 19.2 MHz, the first frequency is 1.75 GHz, the second frequency is 1.05 MHz, and the third frequency is 9.6 MHz.

7. The RF receiver as claimed in claim 6, wherein the first divider comprises:
a digital lookup table, receiving the reference signal, generating a digital signal having a second frequency; and
two analog to digital converters (ADC), each analogizing the digital signal to the second sinusoidal and cosine waves.

8. The RF receiver as claimed in claim 6, wherein the second divider comprises:
a duty cycle unit, receiving the reference signal and generate a corresponding square wave having 1:1 duty cycle; and
a half divider, dividing the square wave by two to generate the third sinusoidal wave and the third cosine wave.

9. A demodulation method, comprising:
down converting an RF signal to a first frequency to generate a first in-phase signal and a first quadrature signal;
performing limiting amplification on the first in-phase signal and the first quadrature signal to generate a second in-phase signal and a second quadrature signal;
up converting the frequency of the second in-phase and quadrature signals to a second frequency to generate a third in-phase signal and a quadrature signal; and
up converting the frequency of the third in-phase and quadrature signals to a third frequency to generate an intermediate frequency (IF) signal.

10. The demodulation method as claimed in claim 9, wherein the step of down converting comprises:
receiving a first sinusoidal wave and a second cosine wave to mix the RF signal; and
amplifying the mixed result and eliminating image components thereof, to generate the first in-phase signal and the first quadrature signal.

11. The demodulation method as claimed in claim 9, wherein the step of limiting amplification comprises eliminating harmonic components in the first in-phase signal and the first quadrature signal.

12. The demodulation method as claimed in claim 9, wherein the up converting of the second in-phase and quadrature signals comprises:
first mixing the second in-phase signal and a second cosine wave;
second mixing the second in-phase signal and a second sinusoidal wave;
third mixing the second quadrature signal and the second sinusoidal wave;
fourth mixing the second quadrature signal and the second cosine wave;
subtracting the third mixed result from the first mixed result;
adding the second and fourth mixed result; and
filtering the subtraction and addition results to generate the third in-phase signal and the third quadrature signal.

13. The demodulation method as claimed in claim 8, wherein the up converting of the third in-phase and quadrature signals comprises:
mixing the third in-phase signal and the third cosine signal;
mixing the third quadrature signal and the third sinusoidal signal;
adding the outputs of the previous two mixed results;
filtering the output of the addition to reserve third frequency signals; and
amplifying the filtered output to generate the IF signal.

14. The demodulation method as claimed in claim 9, further comprising:
providing a reference signal;
generating a first sinusoidal wave and a first cosine wave based on the reference signal, wherein the first sinusoidal wave and the first cosine wave have a first frequency;
generating a second sinusoidal wave and a second cosine wave by looking up a digital table based on the reference signal, wherein the second sinusoidal wave and the second cosine wave have a second frequency;
generating a third sinusoidal wave and a third cosine wave based on the reference signal, wherein the third sinusoidal wave and the third cosine wave have a third frequency; wherein
the reference signal is 19.2 MHz, the first frequency is 1.75 GHz, the second frequency is 1.05 MHz, and the third frequency is 9.6 MHz.

15. The demodulation method as claimed in claim 14, wherein the generation of the second sinusoidal and cosine waves comprises:
generating a digital signal having a second frequency; and
analogizing the digital signal to the second sinusoidal wave and the second cosine wave.

16. The demodulation method as claimed in claim 14, wherein the generation of the third sinusoidal and quadrature waves comprises:
generate a square wave having 1:1 duty cycle based on the reference signal; and
dividing the square wave by two to generate the third sinusoidal wave and the third cosine wave.
